(19) United States
(12) Patent Application Publication
(10) Pub. No.: US 2006/0101875 A1
(43) Pub. Date: May 18, 2006

(54) Container with locking assembly

(76) Inventor: Randy Key, Jonesboro, AR (US)

Correspondence Address: Laura M. Kelley;Myers Bigel Sibley & Sajovec, P.A., P.O. Box 37428, Raleigh, NC, 27627, US

(21) Appl. No.: 10/987,721

(22) Filed: Nov. 12, 2004

(51) Int. Cl. E05B 65/46

(52) U.S. Cl. 70/85

(57) ABSTRACT

A container includes a receptacle having panels and an open end such that at least one of the panels includes a plurality of stop surfaces. A drawer is slideably received in the open end of the receptacle and has a locking member connected thereto. The locking member is movable between a locked position such that a portion of the locking member abuts one of the plurality of stop surfaces to substantially prevent movement of the drawer relative to the receptacle and an unlocked position such that the locking member is retracted from the stop surfaces, thereby allowing the drawer to slide relative to the receptacle. An actuator assembly is on the drawer and has a portion thereof accessible from the open end of the receptacle. The actuator assembly is connected to the locking member such that actuation of the actuator assembly moves the locking member to the unlocked position.

### FIELD OF THE INVENTION

The present invention is directed generally to containers, and more specifically to containers with integrated locking systems.

### BACKGROUND OF THE INVENTION

A truck or van drawer unit is a container that is mounted in the bed of a truck or a van. Ordinarily, a drawer unit is mounted at the back of the bed, with access from the rear of the truck or van. It spans the distance between the wheel wells, and protrudes toward the cab (front) of the vehicle. Items like tools, fasteners, and the like can be stored in the drawer unit rather than simply laying loose in the truck bed. Drawer units are often formed of steel or aluminum sheet and typically include a receptacle that has wall panels and storage compartments, such as shelves or drawers.

The panels and drawers of these types of containers can be formed either from a single sheet of steel that is bent at intersecting edges of these surfaces or from multiple pieces of sheet steel that are welded together. Exemplary drawer units include those sold under the name JOBOX™ by Delta Consolidated Industries, Jonesboro, Ark. and those sold under the name PACK RAT™ by Knaack Manufacturing, Crystal Lake, Ill.

Many of these containers have a locking system to prevent the drawer from moving and/or to prevent unauthorized access to the drawer. For example, a latch at one end of the drawer can be used to alternatively prevent and allow movement of the drawer. However, when the drawer is in the unlatched position, the drawer can rapidly slide out of the container, especially if the drawer unit resides in a vehicle that is positioned on an inclined surface or that accelerates quickly.

### SUMMARY OF THE INVENTION

According to embodiments of the present invention, a container includes a receptacle having panels and an open end such that at least one of the panels includes a plurality of stop surfaces. A drawer is slideably received in the open end of the receptacle and has a locking member connected thereto. The locking member is movable between a locked position such that a portion of the locking member abuts one of the plurality of stop surfaces to substantially prevent movement of the drawer relative to the receptacle and an unlocked position such that the locking member is retracted from the stop surfaces, thereby allowing the drawer to slide relative to the receptacle. An actuator assembly is on the drawer and has a portion thereof accessible from the open end of the receptacle. The actuator assembly is connected to the locking member such that actuation of the actuator assembly moves the locking member to the unlocked position.

In this configuration, the drawer may be locked in a plurality of positions and movement of the drawer relative to the receptacle can be substantially prevented. The drawer may be locked in position at any one of the plurality of stop surfaces such that the drawer may be held in a fully open position or in one of a plurality of partially opened positions.

According to embodiments of the present invention, a container includes a receptacle having panels and an open end such that at least one of the panels includes at least one stop surface. A drawer is slideably received in the open end of the receptacle and has a locking member connected thereto The locking member is movable between a locked position such that a portion of the locking member abuts the stop surface to substantially prevent movement of the drawer relative to the receptacle, and an unlocked position such that the locking member is retracted from the stop surface, thereby allowing the drawer to slide relative to the receptacle. A handle member is on an end of the drawer accessible from the open end of the receptacle. An actuator assembly is on the drawer and has a lever movable between a first position and a second position. The lever is accessible from the open end of the receptacle and positioned adjacent the handle member such that an operator can grasp the handle while moving the first lever toward the handle to the second position. The lever is connected to the locking member such that, when the lever is in the second position, the actuator assembly moves the locking member to the unlocked position.

In this configuration, the operator can move the drawer by grasping the handle while moving the first lever toward the handle in a single movement for ease of operation.

According to further embodiments, a drawer includes a floor, two opposing sidewalls, a front wall and a back wall. A plurality of brackets having slots therein are mounted on at least one of the two opposing sidewalls, the front wall, and the back wall. At least one longitudinal divider has one end mounted in a slot of one of the brackets on the back wall and has another end mounted in a slot of one of the brackets on the front wall. Additional ones of the brackets are mounted on at least one side of the longitudinal divider facing one of the sidewalls. At least one transverse divider has one end mounted in a slot on one of the brackets on one of the sidewalls and another end mounted in a slot of one of the brackets on the longitudinal divider.

### BRIEF DESCRIPTION OF THE FIGURES

FIG. 1 is a perspective view of a container according to embodiments of the present invention, wherein the container is shown in a partially open position.

FIG. 2 is a side section view of the container of FIG. 1 in the closed position.

FIG. 3 is a top section view of the container of FIG. 1 taken along lines 3-3 in FIG. 2.

FIG. 4 is an exploded perspective view of the container of FIG. 1 with the ceiling of the receptacle cut away.

FIG. 5 is an enlarged top section view of the actuator handle of the container of FIG. 1 with the lever of the actuator handle at rest.

FIG. 6 is an enlarged perspective view of the handle bracket of the actuator handle of FIG. 5.

FIG. 7 is an enlarged top perspective view of the locking assembly of the container of FIG. 1 with the ceiling of the receptacle removed.

FIG. 8 is an enlarged side section view of the locking assembly taken along lines 8-8 of FIG. 3 in position with the lock member of the locking assembly extending through apertures in the ceiling of the receptacle.

FIG. 9 is an enlarged top section view of the actuator handle of FIG. 5 with the cam lock in the open position.

FIG. 10 is an enlarged top section view of the actuator handle of FIG. 5 with the lever of the actuator handle in the actuated position.

FIG. 11 is an enlarged side section view of the locking assembly of FIG. 7 with the lock member in the unlocked position.

FIG. 12 is an enlarged side section view of the locking assembly of FIG. 7 with the lock member in the unlocked position with the drawer freely moving with respect to the receptacle.

FIG. 13 is an enlarged side section view of the locking assembly of FIG. 7 with the lock member in the unlocked position adjacent another aperture in the ceiling of the receptacle.

FIG. 14 is an enlarged side section view of the locking assembly of FIG. 7 with the lock member in the locked position received in another aperture in the ceiling of the receptacle.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity. It will be understood that when an element is referred to as being “attached”, “connected”, “interconnected”, “mounted” or “coupled” to another element, it can be directly connected or coupled to the other element or intervening elements may be present. In contrast, when an element is referred to as being “directly” connected, coupled, or the like, to another element, there are no intervening elements present.

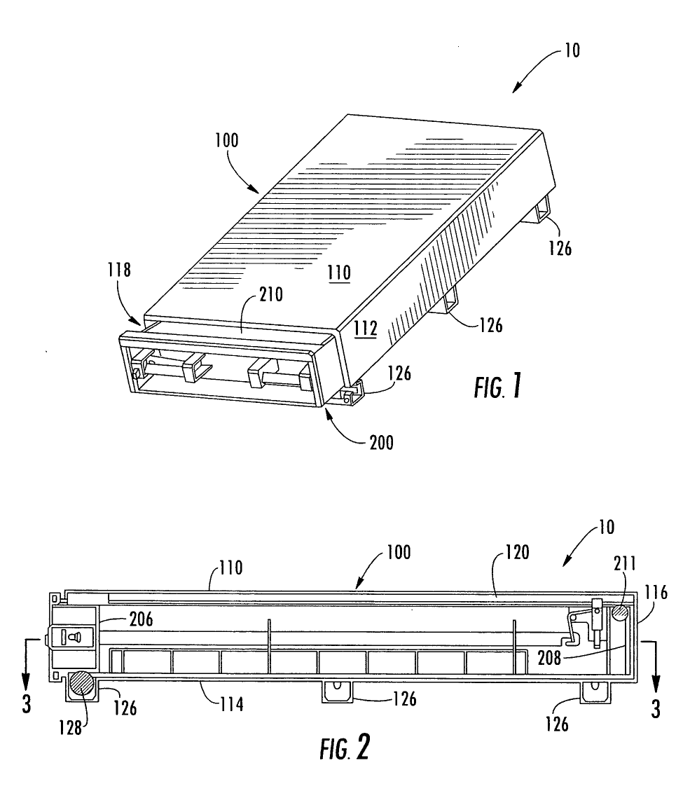

Embodiments according to the present invention are illustrated with respect to FIGS. 1-14. A drawer unit, designated broadly as container 10, is illustrated in FIGS. 1-4. The container 10 includes a receptacle 100 and a drawer 200 that is slideably received therein. The receptacle 100 includes panels, which are illustrated as a ceiling 110, two opposing side walls 112, a floor 114 and a rear wall 116, all of which merge at their edges to form a rectangular box with an open end 118. The container 10 is preferably formed of sheet steel.

As used herein, the terms “outward,” “forward,” “front” and derivatives thereof refer to the direction defined by a vector extending from the rear wall 116 of the receptacle 100 toward the open end 118 parallel to the floor 114. Thus, as illustrated in FIG. 1 the drawer 200 opens in the outward direction. Conversely, the terms “inward,” “rearward” and derivatives thereof refer to the direction directly opposite the forward direction; i.e., the rearward direction is defined by a vector that extends from the open end 118 toward the rear wall 116 parallel to the floor 114. The term “upward” and derivatives thereof refer to the direction defined by a vector originating in the center of the container 10 and extending from the plane of the floor 114 toward the ceiling 110 and perpendicular to the forward and rearward directions. The term “downward” and derivatives thereof refer to the direction directly opposite to the upward direction as defined above.

Those skilled in this art will recognize that the container 10 may take other configurations. For example, more than one drawer 200 may be provided in the receptacle 100. The container 10 may be mounted in a bed of a truck; however, the present invention may be employed with containers other than truck or van drawer units. Those skilled in this art will recognize other appropriate container forms for the present invention.

With reference to FIGS. 1-2, the receptacle 100 is supported by support legs 126 that are welded to the floor 114 and that traverse the floor 114. At least one roller 128 is positioned in at least one of the support legs 126. The roller 128 can be a ball, wheel, cylindrical roller, or the like that rotates to facilitate movement of the drawer 200 in and out of the receptacle 100.

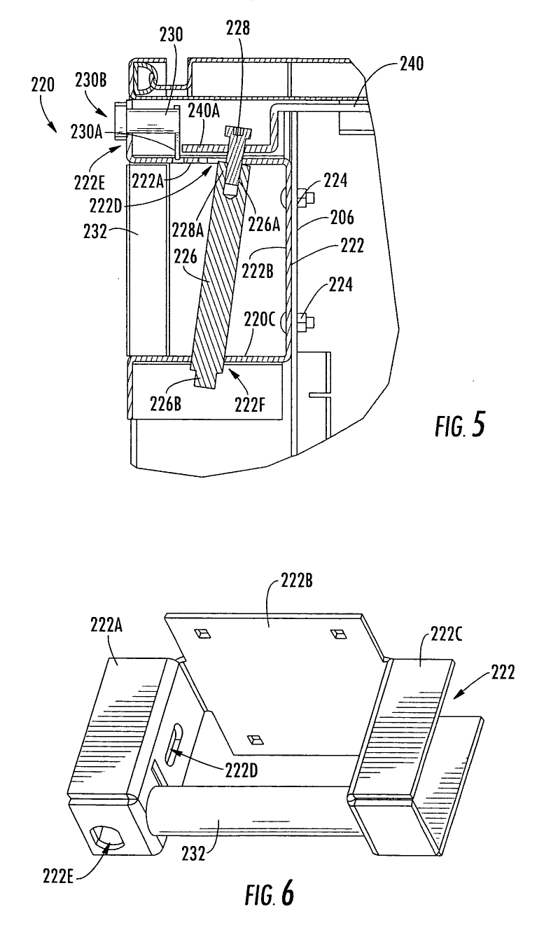

As illustrated in FIGS. 2 and 4, the ceiling 110 of the receptacle 100 includes an upper bracket 120. The upper bracket 120 has a plurality of apertures 122 that define stop surfaces 122A on their forward and rearward edges. The bracket 120 has a generally C-shaped cross-section that is oriented on the ceiling 110 such that the apertures 122 are spaced apart from the ceiling 110. Any number of apertures 122 and corresponding stop surfaces 122A may be provided in the upper bracket 120.

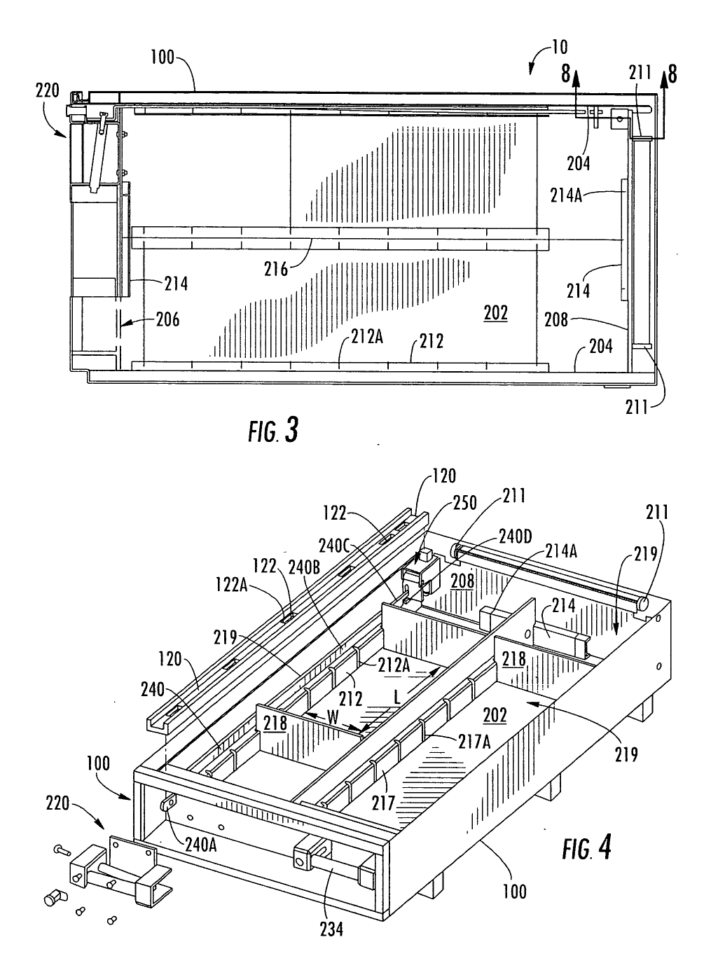

As illustrated in FIGS. 3-4, the drawer 200 includes a floor 202, two opposing side walls 204, a front wall 206 and a back wall 208, all of which merge at their edges to form a rectangular drawer with an open end 210 (FIG. 1). As shown in FIG. 3, rollers 211 are positioned adjacent the upper portions of the back wall 208 and may be permitted to slide along a track 211A (shown in FIG. 8). Another track, such as one or more C-shaped channels with encapsulated bearings, is positioned on the bottom of the receptacle 100 to absorb upward and/or downward forces (not shown). The rollers 211 rotate to facilitate movement of the drawer with respect to the receptacle 100. The rollers 211 can be rotating balls, wheels, cylindrical rollers, or the like. It should be understood that other configurations can be used. For example, additional rollers may be used on the bottom of the receptacle 100 and the track on the bottom of the receptacle 100 may be omitted.

With reference to FIG. 4, side brackets 212, which include slots 212A, are mounted on the side walls 204. Front and back brackets 214 having slots 214A are mounted on the front wall 206 and the back wall 208. The drawer 200 includes longitudinal dividers 216 and transverse dividers 218. Opposing ends of the dividers 216 are held in opposing pairs of the slots 214A and partition the drawer 200 lengthwise. The dividers 216 include brackets 217 that have additional slots 217A. Opposing ends of the dividers 218 are positioned between opposing pairs of slots 212A and 217A to partition the drawer 200 widthwise. In this configuration, the dividers 216 and 218 partition the drawer into compartments 219. The width w and the length l of the compartments 219 can be adjusted by moving the dividers 216 and 218 to various opposing slots 212A, 217A and 214A. For example, the divider 216 can be positioned in various ones of the slots 214A and dividers 218 can be sized and configured to fit in the slots 212A and 217A in the respective brackets 212 and 217.

The drawer 200 includes an actuator handle assembly 220. As illustrated in FIGS. 5-6, the actuator assembly 220 includes a bracket 222 that has a side portion 222A, a middle portion 222B and another side portion 222C. The middle portion 222B is connected to the front wall 206 of the drawer 200 by bolts 224. Other configurations can be used to connect the assembly 220 to the drawer 200. For example, the middle portion 222B may be omitted and the assembly 220 can be connected to the drawer 200 with fasteners, such as pins, bolts or screws on the side portions 222A, 222C. The side portion 222A includes openings 222D and 222E, and the side portion 222C includes an opening 222F. An actuator handle 232 is positioned between the side portions 222A, 222C at the front of the bracket 222. A lever 226 is positioned inside the bracket 222 between the bracket side portions 222A, 222C. The lever 226 has an end 226A that includes a bolt 228 and an end 226B that is positioned in the opening 222F of the bracket 222. The bolt 228 has a shoulder portion 228A that abuts the end 226A of the lever 226. The bolt 228 is positioned in the opening 222D of the bracket 222.

The bolt 228 is connected to a rod 240. As illustrated in FIG. 4, the rod 240 extends along the sidewall 204 of the drawer 200. The rod 240 includes a front end 240A that is connected to the bolt 228, a primary middle portion 240B and a back end 240C. The back end 240C of the rod 240 includes a hook 240D. As shown in FIG. 5, the front end 240A confronts the front wall 206 and is a bent portion that is offset from the primary middle portion 240B. The bent front end 240A confronts the front wall 206 and substantially prevents backward movement of the rod 240 with respect to the receptacle 100.

With continued reference to FIG. 5, the actuator assembly 220 includes a cam lock 230, which is inserted into the opening 222E of the side portion 222A of the bracket 222. The cam lock 230 includes an appendage 230A on a side thereof and a key hole 230B on its front face. In the position illustrated in FIG. 5, the appendage 230A is positioned to substantially prevent forward movement of the rod 240. As described below, the cam lock 230 may be rotated so that the appendage 230A is positioned to allow forward movement of the rod 240. It should be understood that any suitable configuration can be used to substantially prevent and allow forward movement of the rod 240. For example, any block or plate that is moveable between a position that prevents forward movement of the rod 240 and a position that allows forward movement of the rod 240 may be used.

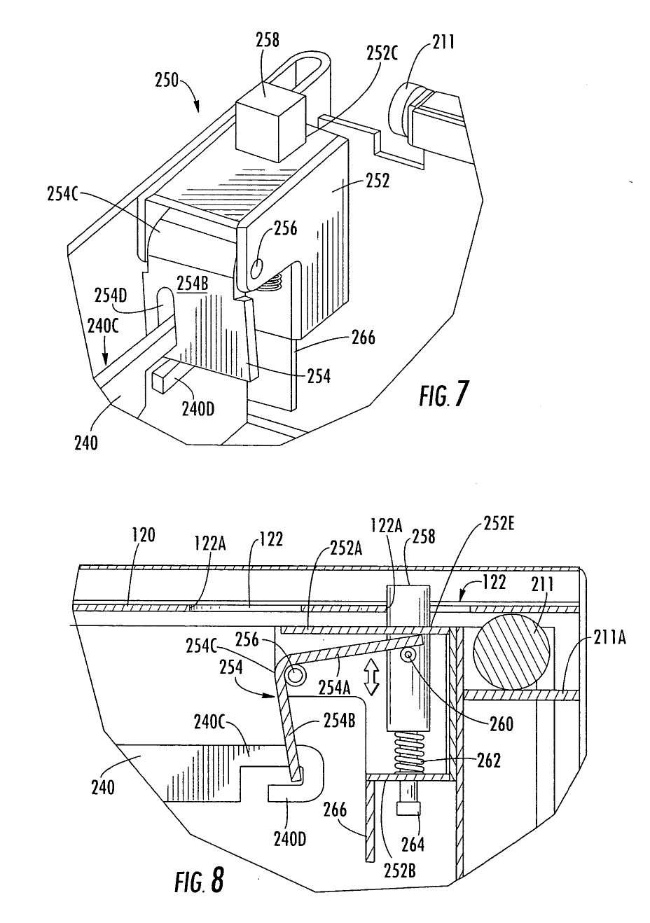

As illustrated in FIG. 4, the drawer 200 includes a locking assembly 250 positioned adjacent the back wall 208 of the drawer 200. As shown in FIGS. 7-8, the locking assembly 250 includes a bracket 252 that has an upper portion 252A and a lower portion 252B. The upper portion 252A includes an opening 252C. The bracket 252 has a pivot rest 256, a lever 254, and a guard member 266. The lever 254 has a top end 254A, a bottom end 254B and a bend or fulcrum 254C. The fulcrum 254C rests on the pivot rest 256 and the lever 254 is configured to pivot about the fulcrum 254C. The bottom end 254B of the lever 254 has a slot 254D. The hook 240D of the rod 240 is connected to the bottom end 254B and passes through the slot 254D.

The bracket 252 includes a lock member 258, which has a rest 260 on its side. The lock member 258 is connected to the bottom portion 252B of the bracket 252 by a connecting member 264 and a spring 262. The connecting member 264 can be a single, unitary member or it can include a separate bolt opposite the spring. The lock member 258 protrudes through the opening 252C of the bracket upper portion 252A.

As illustrated in FIG. 5, the lever 226 is in a disengaged position and the appendage 230A of the cam lock 230 is positioned to abut the end 240A of the rod 240 and substantially prevent forward movement of the rod 240. When the lever 226 is in the disengaged position shown in FIG. 5, the rod 240 (as shown in FIG. 8) disengages the lever 254 of the locking assembly 250 such that the spring 262 exerts a force in the upward direction to maintain the locking member 258 in the locked position, i.e., such that the locking member 258 protrudes above the aperture 122 and abuts the stop surface 122A to prevent movement of the drawer 200 relative to the receptacle 100, as illustrated in FIG. 8.

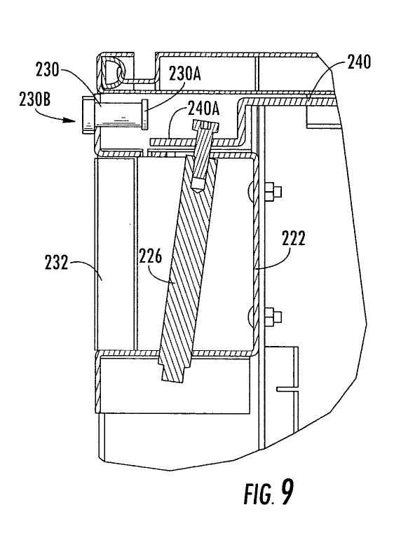

As illustrated in FIG. 9, the cam lock 230 is rotated (as compared to FIG. 5) to an unlocked position. The cam lock 230 may be rotated to the unlocked position shown in FIG. 9 when a key (not shown) is inserted into the key hole 230B to unlock the cam lock 230. As shown, the cam lock 230 and key hole 230B provide security to the contents of the drawer 200 because the cam lock 230 cannot be rotated to the unlocked position without the key. However, the cam lock 230 may be omitted in some embodiments.

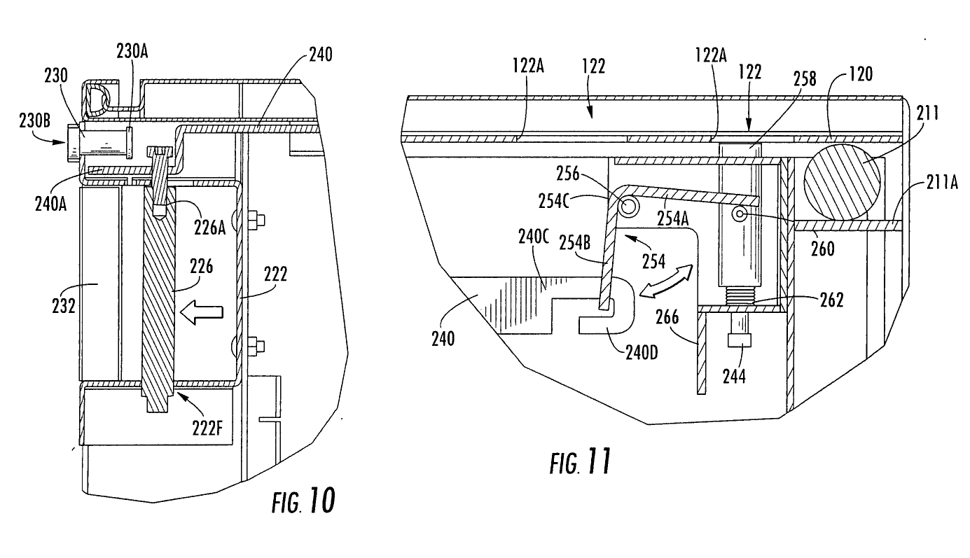

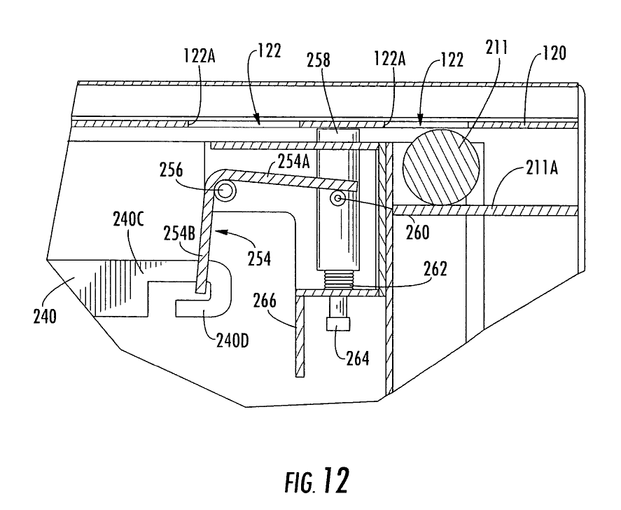

As shown in FIG. 10, the lever 226 pivots in the bracket opening 222F, which is spaced apart from the lever end 226A. The lever end 226A moves in an outward direction with respect to the drawer 200 such that the lever 226 is in an engaged position. The movement of the lever 226 forces the rod 240 to move in a direction substantially parallel to the side wall 204 that is positioned adjacent the rod 240. The rod 240 is permitted to move because the cam lock 230 is in the unlocked position. The lever 226 is positioned with respect to the handle 232 such that an operator can grasp the handle while moving the lever 226 toward the handle 232 to the engaged position shown in FIG. 10.

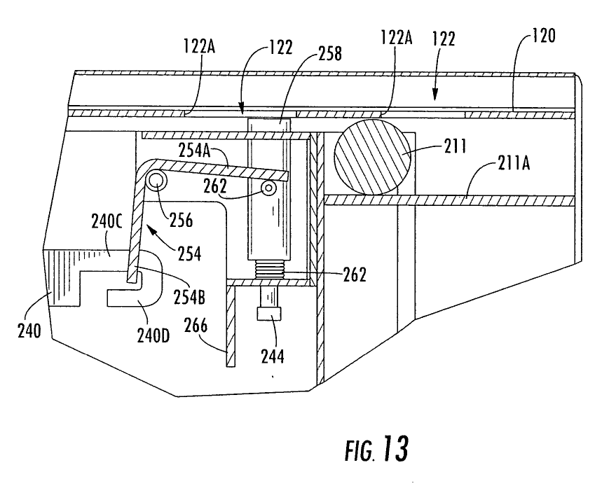

As a result of movement of the lever 226 and the rod 240 in FIG. 10, the rod end 240C moves away from the locking assembly 250 and consequently moves the lever 254 to pivot about the fulcrum 254C, as shown in FIG. 11. The top end 254A of the lever 254 exerts a downward force on the rest 260 of the locking member 258. The downward force is in the opposite direction of the force of the spring 262. As a result, the locking member 258 is pressed downward and the spring 262 is compressed. In this configuration, the lever 254 transforms horizontal motion of the rod 240 to vertical motion of the locking member 258. The locking member 258 is moved to the unlocked position such that the locking member 258 is retracted from the stop surfaces 122A.

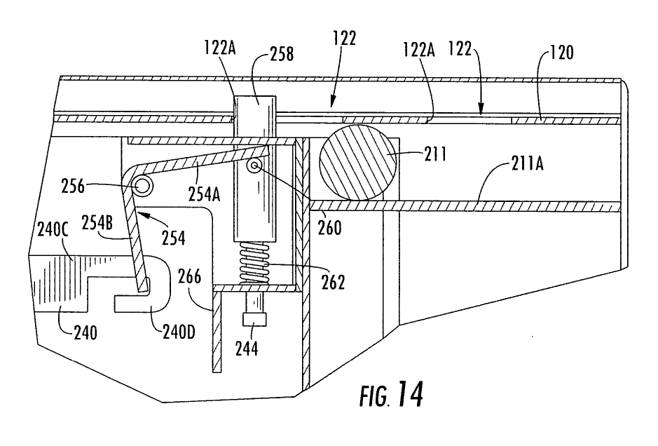

As illustrated in FIGS. 12-13, the locking member 258 is in the unlocked position, which allows the drawer 200 to slide relative to the receptacle 100. The guard member 266 is configured to substantially prevent objects in the drawer 200 from stacking or being positioned under the locking assembly 250 when the drawer 200 slides relative to the receptacle, which would potentially obstruct movement of the spring 262. In FIG. 12, the locking member 258 moves adjacent the upper bracket 120 and between adjacent apertures 122, and the drawer 200 slides outward from the receptacle 100. In FIG. 13, the locking member 258 moves beneath another aperture 122. In FIG. 14, the locking member 258 is returned to the locked position when the lever 226 is moved back to the disengaged position shown in FIGS. 5 and 9. The locking member 258 abuts another one of the stop surfaces 122A. Consequently, the drawer 200 is locked in a partially opened position with respect to the receptacle 100. It should be understood that the locking member 258 may be positioned to abut any one of the stop surfaces 122A to lock the drawer 200 in various positions with respect to the receptacle 100.

In this configuration, the locking member 258 is movable between a locked position such that a portion thereof abuts one of the plurality of stop surfaces 122A to substantially prevent movement of the drawer 200 relative to the receptacle 100, and an unlocked position such that the locking member 258 is retracted from the stop surfaces 122A, thereby allowing the drawer 200 to slide relative to the receptacle. The actuator assembly 220, which is accessible from the open end 118 of the receptacle 100, is connected to the locking member 258 such that actuation of the actuator assembly 220 moves the locking member 258 to the unlocked position.

Although the stop surfaces 122A are described herein as being positioned on the ceiling 110 of the receptacle 100, it should be understood that other configurations can be used. For example, the stop surface 122A can be provided on the sidewalls 112 or the floor 114 of the receptacle, and the locking assembly 250 may be positioned such that the locking member 258 is adjacent the stop surfaces 122A to interact with the stop surfaces 122A as described herein. However, when the stop surfaces 122A are located on the ceiling 110 of the receptacle 100, the area of the drawer 200 and the width thereof that can be used for storage may be maximized because the stop surfaces 122A and the locking assembly 250 do not require additional space adjacent the sidewalls 112 of the receptacle 100. Moreover, although the stop surfaces 122A are described as being on a side of the apertures 122, it should be understood that other configurations can be used. For example, the stop surfaces 122A can be provided by a suitably shaped protrusion or recess that is offset from the receptacle ceiling 110 such that, when the locking member 258 is in the locked position, a portion thereof abuts the stop surface 122A.

The locking assembly 250 of the container 10 described herein is positioned adjacent the back wall 208 of the drawer 200. In this configuration, the drawer 200 may be locked in an entirely or almost entirely opened position when the locking member 258 abuts the forward most stop surface 122A on the upper bracket 120. The drawer 200 may also be locked in position at any one of a plurality of partially opened positions. However, it should be understood that the locking assembly 250 may be positioned at any location along the length of the drawer 200.

If the locking member 258 is in the unlocked position between apertures 122 (as shown in FIG. 12) and the lever 226 and the rod 240 are in the disengaged position (as shown in FIGS. 5 and 9), then the drawer 200 will generally slide no farther than the point at which the locking member 258 abuts that next stop surface 122A (as shown in FIG. 14). Therefore, if the container 10 resides in a vehicle that is positioned on an inclined surface, the drawer 200 will generally not slide completely out of the receptacle.

The foregoing is illustrative of the present invention, and is not to be construed as limiting thereof. Although exemplary embodiments of this invention have been described, those skilled in the art will readily appreciate that many modifications are possible in the exemplary embodiments without materially departing from the novel teachings and advantages of this invention. As such, all such modifications are intended to be included within the scope of this invention. The scope of the invention is to be defined by the following claims.

That Which is claimed is:

1. A container, comprising:
a receptacle having panels and an open end, at least one of the panels comprising a plurality of stop surfaces;
a drawer slideably received in the open end of the receptacle and having a locking member connected thereto, wherein the locking member is movable between a locked position such that a portion of the locking member abuts one of the plurality of stop surfaces to substantially prevent movement of the drawer relative to the receptacle, and an unlocked position such that the locking member is retracted from the stop surfaces, thereby allowing the drawer to slide relative to the receptacle; and
an actuator assembly on the drawer and having a portion thereof accessible from the open end of the receptacle, the actuator assembly being connected to the locking member such that actuation of the actuator assembly moves the locking member to the unlocked position.

2. The container of claim 1, wherein the locking member comprises a spring which biases the locking member toward the locked position.

3. The container of claim 2, wherein the actuator assembly comprises:
a first lever on the end of the drawer accessible from the open end of the receptacle, the first lever being movable between a first position and a second position;
a rod having an end connected to the first lever, a primary portion adjacent at least one of the side walls and another end opposite the first lever;
a second lever having one end connected to the end of the rod opposite the first lever and having another end connected to the locking member; and
wherein when the first lever is in the first position, the rod disengages the second lever such that the spring exerts a force in a direction to maintain the locking member in the locked position, and when the first lever is in the second position, the rod engages the second lever to exert another force in a direction opposite the force of the spring to thereby move the locking member to the unlocked position.

4. The container of claim 3, wherein the actuator assembly comprises a bracket member and wherein the first lever is pivotally mounted in the bracket at an end thereof spaced apart from the rod such that the first lever pivots between the first position and the second position to move the rod in a direction substantially parallel to the side wall adjacent the rod.

5. The container of claim 4, wherein the actuator assembly comprises a cam lock configured to rotate between an open position and a closed position, wherein when the cam lock is in the closed position, a portion of the cam lock abuts the end of the rod connected to the first lever and substantially prevents movement of the rod so that the rod does not engage the second lever, and when the cam lock is in the open position, the rod is permitted to move to engage the second lever.

6. The container of claim 3, further comprising a handle member on an end of the drawer accessible from the open end of the receptacle, wherein the first lever is positioned adjacent the handle member such that an operator can grasp the handle while moving the first lever toward the handle and to the second position.

7. The container of claim 3, wherein the second lever includes a bend between the end connected to the rod and the end connected to the locking member so that the second lever transforms horizontal motion of the rod to vertical motion of the locking member.

8. The container of claim 3, wherein the rod end connected to the first lever comprises a bent portion offset from the rod primary portion.

9. The container of claim 1, wherein the locking member is positioned at an end of the drawer opposite the open end of the receptacle.

10. The container of claim 1, wherein the stop surfaces comprise edges of apertures.

11. The container of claim 1, wherein the drawer comprises a bottom and an open top, wherein the stop surfaces are mounted to a receptacle panel adjacent the open top of the drawer.

12. The container of claim 1, wherein the container is formed of sheet steel.

13. The container of claim 1, wherein the container is mounted in a bed of a truck or van.

14. The container of claim 1, wherein the drawer comprises:
a floor, two opposing sidewalls, a front wall and a back wall;
a plurality of brackets having slots therein, the brackets being mounted on at least one of the two opposing sidewalls, the front wall, and the back wall;
at least one longitudinal divider having one end mounted in a slot of one of the brackets on the back wall and having another end mounted in a slot of one of the brackets on the front wall, wherein additional ones of the brackets are mounted on at least one side of the longitudinal divider facing one of the sidewalls; and
at least one transverse divider having one end mounted in a slot on one of the brackets on one of the sidewalls and another end mounted in a slot of one of the brackets on the longitudinal divider.

15. A container, comprising:
a receptacle having panels and an open end, at least one of the panels comprising at least one stop surface;
a drawer slideably received in the open end of the receptacle and having a locking member connected thereto, wherein the locking member is movable between a locked position such that a portion of the locking member abuts the stop surface to substantially prevent movement of the drawer relative to the receptacle, and an unlocked position such that the locking member is retracted from the stop surface, thereby allowing the drawer to slide relative to the receptacle;
a handle member on an end of the drawer accessible from the open end of the receptacle;
an actuator assembly on the drawer and having a lever movable between a first position and a second position, wherein the lever is accessible from the open end of the receptacle and positioned adjacent the handle member such that an operator can grasp the handle while moving the lever toward the handle from the first position to the second position, and wherein the lever is connected to the locking member such that, when the lever is in the second position, the actuator assembly moves the locking member to the unlocked position.

16. The container of claim 15, wherein the locking member comprises a spring adapted to maintain the locking member in the locked position.

17. The container of claim 16, wherein the actuator assembly lever is a first lever, and wherein the actuator assembly comprises:
a rod having an end connected to the first lever, a primary portion adjacent at least one of the side walls and another end opposite the first lever;
a second lever having one end connected to the end of the rod opposite the first lever and having another end connected to the locking member; and
wherein when the first lever is in the first position, the rod disengages the second lever such that the spring exerts a force in a direction to maintain the locking member in the locked position, and when the first lever is in the second position, the rod engages the second lever to exert another force in a direction opposite the force of the spring to thereby move the locking member to the unlocked position.

18. The container of claim 17, wherein the actuator assembly comprises a bracket member and wherein the first lever is pivotally mounted in the bracket at an end thereof spaced apart from the rod such that the first lever pivots between the first position and the second position to move the rod in a direction substantially parallel to the side wall adjacent the rod.

19. The container of claim 18, wherein the actuator assembly comprises a cam lock configured to rotate between an open position and a closed position, wherein when the cam lock is in the closed position, a portion of the cam lock abuts the end of the rod connected to the first lever and substantially prevents movement of the rod so that the rod does not engage the second lever, and when the cam lock is in the open position, the rod is permitted to move to engage the second lever.

20. The container of claim 17, wherein the second lever includes a bend between the end connected to the rod and the end connected to the locking member so that the second lever transforms horizontal motion of the rod to vertical motion of the locking member.

21. The container of claim 17, wherein the rod end connected to the first lever comprises a bent portion offset from the rod primary portion.

22. The container of claim 15, wherein the locking member is positioned at an end of the drawer opposite the open end of the receptacle.

23. The container of claim 15, wherein the at least one stop surface comprises an edge of an aperture.

24. The container of claim 15, wherein the drawer comprises a bottom and an open top end, wherein the at least one stop surface is mounted to a receptacle panel adjacent the open top end of the drawer.

25. The container of claim 15, wherein the container is formed of sheet steel.

26. The container of claim 15, wherein the container is mounted in a bed of a truck or van.

27. The container of claim 15, wherein the drawer comprises:
a floor, two opposing sidewalls, a front wall and a back wall;
a plurality of brackets having slots therein, the brackets being mounted on at least one of the two opposing sidewalls, the front wall, and the back wall;
at least one longitudinal divider having one end mounted in a slot of one of the brackets on the back wall and having another end mounted in a slot of one of the brackets on the front wall, wherein additional ones of the brackets are mounted on at least one side of the longitudinal divider facing one of the sidewalls; and
at least one transverse divider having one end mounted in a slot on one of the brackets on one of the sidewalls and another end mounted in a slot of one of the brackets on the longitudinal divider.

28. A drawer comprising:
a floor, two opposing sidewalls, a front wall and a back wall;
a plurality of brackets having a plurality of slots therein, the brackets being mounted on at least one of the two opposing sidewalls, the front wall, and the back wall;
at least one longitudinal divider having one end mounted in a slot of one of the brackets on the back wall and having another end mounted in a slot of one of the brackets on the front wall, wherein additional ones of the brackets are mounted on at least one side of the longitudinal divider facing one of the sidewalls; and
at least one transverse divider having one end mounted in a slot on one of the brackets on one of the sidewalls and another end mounted in a slot of one of the brackets on the longitudinal divider.

29. The drawer of claim 28, wherein the longitudinal and transverse dividers partition the drawer into a plurality of compartments such that the longitudinal length of the compartments can be adjusted by moving the transverse divider.
